(19) United States
(12) Patent Application Publication
(10) Pub. No.: US 2024/0085563 A1
(43) Pub. Date: Mar. 14, 2024

(54) RADIATION-EMITTING DEVICE, MEASURING SYSTEM COMPRISING THE RADIATION-EMITTING DEVICE, AND VEHICLE COMPRISING THE MEASURING SYSTEM

(71) Applicant: ams-OSRAM International GmbH, Regensburg (DE)

(72) Inventors: Peter BRICK, Regensburg (DE); Farhang Ghasemi Afshar, Wenzenbach (DE); Martin HETZL, Painten (DE); Simon LANKES, Regensburg (DE); Reiner WINDISCH, Pettendorf (DE); Ralph Wirth, Lappersdorf (DE)

(21) Appl. No.: 18/260,939

(22) PCT Filed: Dec. 17, 2021
(86) PCT No.: PCT/EP2021/086525

§ 371 Date: Jul. 11, 2023

(30) Foreign Application Priority Data
Jan. 14, 2021 (DE) 10 2021 100 663.5

(51) Int. Cl. G01S 17/931; G01S 7/481

(52) U.S. Cl. CPC G01S 17/931; G01S 7/4813; G01S 7/4814

(57) ABSTRACT

A radiation emitting device for emitting light may include a laser light source configured to emit light along an emitting direction, and a non-imaging optical system arranged downstream of the laser light source in the emitting direction. The optical system may include a plurality of optical elements arranged along the emitting direction for shaping a radiation characteristic of the radiation emitting device in a horizontal direction and a vertical direction perpendicular to the horizontal direction, such that the radiation characteristic is asymmetrical along the vertical direction. A first optical element of the optical system may be configured to cause spreading of the light along the horizontal direction; a second optical element of the optical system may be configured to cause collimation of the light along the vertical direction, and a third optical element of the optical system may be configured to cause radiation asymmetry along the vertical direction.

### CROSS-REFERENCE TO RELATED APPLICATIONS

The present application is a national stage entry according to 35 U.S.C. § 371 of PCT application No.: PCT/EP2021/086525 filed on Dec. 17, 2021; which claims priority to German patent application 10 2021 100 663.5, filed on Jan. 14, 2021; all of which are incorporated herein by reference in their entirety and for all purposes.

### TECHNICAL FIELD

A radiation emitting device is specified. In particular, the radiation emitting device can be used for a measurement system, such as for performing a method known as LIDAR (“light detection and ranging”), which can be used to one or more optical measurement methods, for example optical distance and speed measurements. Furthermore, the measurement system can be used in a device such as a vehicle.

### BACKGROUND

Especially with respect to automotive LIDAR systems, many applications require a high detectable range in a preferred direction, while a reduced detectable range in one or more other directions is often sufficient. For example, a high detectable range may be desired for the central forward direction and a reduced detectable range in the periphery, or vice versa. In principle, to increase the range in a particular direction, the light power emitted in that direction must be increased. If the system is implemented using a flash system type, the complete scene is simultaneously illuminated by a light pulse and the reflected light is detected by a time-resolved camera system. The same applies to CW (continuous wave) type LIDAR systems, where a continuously modulated light beam is emitted instead of light pulses and, for example, the phase shift of the returning light is detected.

Typically, a matrix, also known as an array, of emitters is used for illumination in automotive applications. The emitted light is projected in the direction of the potential target typically with imaging or projection optics that transmit the intensity distribution of the light source, for example, onto the road. Since the light source is typically a matrix of uniformly distributed emitters, this results in a homogeneous intensity distribution over all angles. As a result, the intensity in the center is often insufficient for the desired measurement range, while a light intensity that is too high is provided in the periphery. Particularly in vertical directions, this leads to a waste of energy, since the light beam downward hits the road surface after only a few meters, which limits the desired range, since only objects closer than the road surface should be detected. Even in angular directions pointing upwards, only a limited range is required, since objects at a height of more than about five meters above the road are of no interest for driving. At lower ranges, however, detection of objects at such angles is mandatory. Therefore, LIDAR systems must cover a large field of view, resulting in a lot of unnecessary light emission at such large angles if the systems are embodied for homogeneous radiation.

An established method to circumvent this problem is to use arrays of individually addressable emitters, or at least groups of emitters that can be controlled separately. In such systems, a larger number of pulses can be radiated in the most relevant directions, resulting in a longer range due to noise reduction by averaging over multiple pulses. Those transmitter emitters that contribute only to that angular range where reduced range is sufficient are pulsed at a reduced frequency, which reduces the transmission power and thus the maximum detectable range. However, this method requires individually addressable arrays, which are more expensive to manufacture than arrays with all emitters fully connected in parallel. In addition, this method is not suitable when the resolution of the emitter array is insufficient to modulate the desired intensity appropriately. In particular, it is not practical when only a few high power emitters such as edge emitting lasers are used.

At least one objective of certain embodiments is to provide a radiation emitting device. Further objectives of certain embodiments are to provide a measurement system comprising the radiation emitting device and a vehicle comprising the measurement system.

### SUMMARY

According to at least one embodiment, a radiation emitting device comprises a laser light source for emitting electromagnetic radiation, which may also be referred to herein and hereinafter as light, wherein the laser light source emits the light along an emission direction during operation. Here and hereinafter, “radiation” or “light” may particularly refer to electromagnetic radiation having one or more wavelengths or wavelength ranges from an ultraviolet to infrared spectral range. In particular, light or radiation described herein and below may be infrared light or visible light and may have or be wavelengths or wavelength ranges from an infrared spectral range between about 800 nm and about 3 μm or from a visible spectral range between about 350 nm and about 800 nm. Further, the radiation emitting device has a non-imaging optical system downstream of the laser light source in the direction of emission.

According to at least one further embodiment, a measurement system comprises such a radiation emitting device. Furthermore, the measurement system comprises a detector unit. The detector unit is intended and embodied to detect light emitted by the radiation emitting device and reflected to the detector unit. The radiation emitting device may in particular form a transmitter unit of the measurement system and be intended and embodied to emit at least one light pulse or a continuously emitted light as a transmitter signal during operation. A light pulse may, for example, take the form of a square pulse, a sawtooth pulse, a triangular pulse, a half-wave, or a combination thereof, depending on the desired application. A continuously emitted light may in particular be modulated, for example amplitude and/or phase modulated. The detector unit is intended and embodied to receive a return signal comprising at least a portion of the transmitter signal reflected back from an external object. Accordingly, the return signal may correspond, for example, to a transmitter signal attenuated at least with respect to some spectral components and/or at least partially frequency-shifted and/or at least partially phase-shifted, which may be caused by interactions of the transmitter signal with the object. In a method for operating such a measurement system, the radiation emitting device formed as a transmitter unit transmits a transmitter signal. The receiver unit detects the return signal. For example, the method may be used to determine one or more parameters related to the transmitter signal and/or the return signal. For example, the one or more parameters may be selected from a time difference between the transmitter signal and the return signal, a wavelength shift and/or phase shift between the transmitter signal and the return signal, a spectral changes between the transmitter signal and the return signal. From the one or more parameters determined by evaluation, one or more state variables related to the object reflecting the transmitter signal at least partially can be derived, for example a distance and/or a velocity and/or at least one or more velocity components and/or at least part of a chemical and/or physical composition. For parameter determination, the measurement system may further comprise an evaluation unit intended and embodied for this purpose. In particular, the measurement system may have characteristics and features of a LIDAR system or be a LIDAR system.

According to at least one further embodiment, a vehicle comprises such a measurement system. The vehicle may be, for example, a road vehicle, a rail-bound vehicle, a water vehicle or an aircraft. In an embodiment, the vehicle is a motor vehicle such as a passenger car or a truck. Further, it is also possible to use the measurement system, for example, in another device such as a fixed installation, such as a monitoring device. Accordingly, such a device, such as a monitoring device, for example for a traffic management, a parking management, a security application or industrial purposes, may comprise the measurement system.

The foregoing and following description refers equally to the radiation emitting device, the measurement system with the radiation emitting device, and uses of the measurement system, such as a vehicle or a fixed device with the measurement system.

In the following description, directional terms such as “horizontal” and “vertical” are used. These terms refer to such an arrangement in which the measurement system and, in particular, the radiation emitting device in the measurement system are oriented relative to the surroundings for the intended use. For example, if the measurement system is used in a vehicle such as a road vehicle, the horizontal direction refers to a direction parallel or at least substantially parallel to the road surface. The vertical direction, which is perpendicular to the horizontal direction, then corresponds to a direction perpendicular or at least substantially perpendicular to the road surface. The radiation direction may be perpendicular or substantially perpendicular to the vertical direction and to the horizontal direction.

Terms such as “perpendicular” or “parallel” may each refer herein and hereinafter to an exact perpendicular or parallel arrangement. Furthermore, perpendicular or parallel arrangements may in each case also deviate from the respective exact arrangement by a small angle, which may, for example, be due to an assembly tolerance or external circumstances and which may, for example, be less than or equal to 10° or less than or equal to 5° or less than or equal to 3° or less than or equal to 1°.

According to a further embodiment, the laser light source comprises at least one laser emitter unit. In an embodiment, the laser light source comprises a plurality of laser emitter units. In particular, the laser light source has at least one semiconductor laser diode. The semiconductor laser diode, which may in particular be in the form of a laser diode chip, is intended and embodied to emit light during operation, which is laser light at least when certain threshold conditions are exceeded. For simplification, it is therefore assumed in the following that the radiation-emitting device emits laser light during operation.

According to a further embodiment, the at least one semiconductor laser diode has at least one active layer which is embodied and intended to generate light in an active region during operation. The active layer can in particular be part of a semiconductor layer sequence with a plurality of semiconductor layers and have a main extension plane that is perpendicular to an arrangement direction of the layers of the semiconductor layer sequence. For example, the active layer may have exactly one active region. Furthermore, the semiconductor laser diode can also have a plurality of active layers that can be stacked on top of each other within the semiconductor layer sequence and connected in series with each other, for example, via tunnel junctions. In an embodiment, the light generated by the laser light source is long-wavelength light in the infrared spectral range and has a wavelength greater than or equal to 800 nm or greater than or equal to 850 nm. Further, the light may have a wavelength of less than or equal to 2 μm or less than or equal to 1.5 μm or less than or equal to 1 μm. A wavelength of light produced by the laser light source may be about 940 nm. For example, a semiconductor layer sequence or at least one active layer based on InₓGa_{y}Al_{1-x-y}As or based on InₓGa_{y}Al_{1-x-y}P is suitable for long-wave infrared radiation, where 0≤x≤1, 0≤y≤1 and x+y≤1 apply, respectively.

The semiconductor laser diode can, for example, be embodied as an edge-emitting laser diode in which the light generated in the at least one active layer during operation is emitted via a side surface embodied as a facet, which can be embodied perpendicular to the at least one active layer. Alternatively, the semiconductor laser diode can also be embodied, for example, as a vertically emitting laser diode such as a VCSEL diode (VCSEL: “vertical-cavity surface-emitting laser”), in which the light generated in the at least one active layer during operation is emitted via a surface of the semiconductor layer sequence arranged parallel to the active layer. Furthermore, a vertically emitting laser diode in the form of an edge-emitting laser diode with integrated deflection optics is also possible, for example.

A laser emitter unit may be formed by a semiconductor laser diode, for example. If the laser light source has a plurality of laser emitter units, this means, for example, that the laser light source has a plurality of semiconductor laser diodes. Further, a semiconductor laser diode may also have a plurality of active regions and/or active layers that may form a plurality of laser emitter units. For example, in the case of an edge emitting laser diode, such a semiconductor laser diode may be formed as a laser bar having at least one active layer with a plurality of active regions arranged side by side and/or as a stacked semiconductor laser diode having a plurality of active layers arranged on top of each other. In this case, the laser light source may thus comprise a one-dimensional array of laser emitter units. If each active layer of a plurality of active layers has a plurality of active regions arranged side by side, i.e., if the semiconductor laser diode is formed as a laser bar with stacked active layers, the laser light source may have a two-dimensional array of laser emitter units. Furthermore, in the case of a vertically emitting laser diode, a semiconductor laser diode with a plurality of laser emitter units may have a plurality of active regions arranged in the semiconductor layer sequence in a matrix-like manner. In this case, the laser light source may thus have a two-dimensional array of laser emitter units. In an embodiment, the laser light source has a plurality of laser emitter units and the plurality of laser emitter units is arranged as a one-dimensional array along the horizontal direction. Further, the laser light source may have a plurality of laser emitter units and the plurality of laser emitter units are arranged in a matrix-like manner in a plane spanned by the horizontal and vertical directions. Depending on the design of the laser light source, i.e. in particular the semiconductor laser diode(s), the laser emitter units can be controlled individually, in groups or all together. In an embodiment, the laser emitter units are all controlled together and thus in parallel during operation.

According to a further embodiment, the radiation-emitting device has a housing body in which the laser light source is arranged. This can mean in particular that, depending on the design of the laser light source, a semiconductor laser diode or a plurality of semiconductor laser diodes is arranged in the housing body and, optionally, electrically connected.

The detector unit of the measurement system may also comprise a housing body in which a detector element, for example in the form of a photodiode or photodiode array, is arranged. For example, the detector unit may comprise a SPAD array (SPAD: “single-photon avalanche diode”), an APD array (APD: “avalanche photodiode”) or a so-called gated imaging system. Furthermore, the laser light source and the detector unit can be arranged in a common housing body. In this case, it can be advantageous if the housing body has an optical separation between the laser light source and the detector unit, for example in the form of a partition wall.

According to a further embodiment, the optical system is embodied for shaping a radiation characteristic of the radiation-emitting device, i.e. for shaping the radiation characteristic of the light emitted by the radiation-emitting device, in a horizontal direction and in a vertical direction. In particular, the optical system for shaping the radiation characteristic is intended and embodied such that the radiation characteristic may be asymmetrical along the vertical direction and further may be symmetrical along the horizontal direction. In operation, the radiation emitting device thus may emit light into the surroundings which has an asymmetrical beam profile in the vertical direction. In this way, it can be achieved that the light is directed with a desired intensity distribution in the direction in which it is needed, while in the horizontal direction, radiation is as uniform as possible to the left and right.

According to a further embodiment, the optical system comprises a plurality of optical elements arranged along the radiation direction for shaping the radiation pattern of the radiation emitting device. In an embodiment, the optical elements are the only components of the optical system that contribute to shaping the radiation pattern of the light emitted by the laser light source and that form a non-imaging optical system. In other words, the radiation emitting device does not have any other component in addition to the laser light source and the optical system that significantly affects the radiation pattern. The optical elements of the optical system may be arranged in series along the radiation direction.

The optical elements can have independent optical effects with respect to the light emitted by the laser light source, the totality of these effects providing the desired radiation characteristic of the radiation emitting device. In particular, the radiation characteristic of the radiation emitting device is different from the radiation characteristic of the laser light source.

Semiconductor laser diodes exhibit typical radiation characteristics that depend on the particular structure and properties. For example, edge-emitting laser diodes emit the light generated in an active region with a different beam angle in a plane parallel to the main extension plane of the active layer than in a plane perpendicular to the main extension plane of the active layer. In other words, the aperture angles of the beam profile of a semiconductor laser diode may be different in the two said planes. The plane or direction in which the beam profile has the largest opening angle is also referred to as the fast axis, while the plane or direction in which the beam profile has the smallest opening angle is referred to as the slow axis. In an embodiment, the laser light source in the radiation emitting device and further in the measurement system is aligned in such a way that the fast axis of the light emitted by the laser light source is aligned along the horizontal direction.

In particular, a first optical element of the optical system can be intended and configured to cause a spreading of the light along the horizontal direction. This can mean in particular that the first optical element changes the aperture angle of the light emitted by the laser light source in the horizontal direction, i.e. the horizontal aperture angle, in such a way that a desired angular range is illuminated in the horizontal direction. In an embodiment, the horizontal spreading causes a radiation intensity that is as uniform as possible as a function of the angle in a desired angular range, which may be in particular larger than the aperture angle of the beam profile of the laser light source along the horizontal direction. In particular, the horizontal spread may be symmetrical. This can mean in particular that the angle-dependent radiation intensity distribution in the horizontal direction is symmetrical to the left and right.

Furthermore, a second optical element of the optical system can be intended and configured to effect collimation of the light along the vertical direction. In particular, this can mean that the second optical element changes the aperture angle of the light emitted by the laser light source in the vertical direction, i.e. the vertical aperture angle, so that the illuminated angular range is smaller than the aperture angle of the beam profile of the laser light source.

Furthermore, a third optical element of the optical system may be intended and configured to cause radiation asymmetry along the vertical direction. In particular, this can mean that the radiation direction of the light emitted by the radiation emitting device, i.e. the light emerging from the optical system, is inclined to the radiation direction of the laser light source in the vertical direction.

According to a further embodiment, the first optical element and/or the second optical element comprises a lens body. Such a lens body may also be referred to as a bulk lens. In particular, the first optical element and/or the second optical element may comprise or be formed by a macroscopic lens surface. For example, the first optical element may have or be formed by a concave lens surface, particularly a cylindrical-lens-like lens surface. The second optical element may, for example, have or be formed by a convex lens surface, in particular a cylindrical-lens-like lens surface. “Cylindrical-lens-like” may mean here and hereinafter in particular that the shape of a section through a surface of the optical element is at least sectionally describable as a conic section, as a conic, as an aspheric, as a polynomial, or as a combination thereof. If the first and second optical elements have a lens body, this can be a common lens body whose one lens surface forms the first optical element and whose other lens surface forms the second optical element.

According to a further embodiment, the first optical element and/or the third optical element comprise a microlens array having a plurality of microlenses. The laser light source comprises at least one laser emitter unit and an optional plurality of laser emitter units, and each laser emitter unit may emit light onto a plurality of the microlenses during operation. The microlenses, while a distance between the laser light source and the microlenses is selected to be sufficiently large, have a dimension at least in the horizontal direction or in the vertical direction that is so small that the light from the laser light source, and in particular the light from each laser emitter unit, is incident on a plurality of microlenses. The microlenses may be formed by structures extending one-dimensionally in one direction. In other words, each of the microlenses may be formed by a cylindrical lens. Cylindrical lenses may be referred to herein and hereinafter as structures formed in a cylindrical-lens-like manner as described further above. For example, a cylindrical lens may have a lens surface corresponding to a shape extruded along a direction, wherein the lens surface may correspond to a portion of a lateral surface of a cylinder having a round and/or square base. A “shape extruded along a direction” refers in particular to a geometrical description of the shape and is not to be understood restrictively in terms of the manufacturing process. In particular, such a shape may extend along an extrusion path, also referred to as an extrusion direction, whose direction vector deviates from the plane of symmetry by a maximum of 30° or a maximum of 20° or a maximum of 10°.

In particular, the first optical element may have structures extending in the vertical direction that are cylindrical-lens-like in particular. These structures forming the microlenses may be symmetrical in the horizontal direction. A symmetrical formation of a cylindrical-lens-like microlens in a certain direction means here and in the following that there exists a plane of symmetry perpendicular to this certain direction, with respect to which the microlens is symmetrical, wherein the extrusion direction of the microlens lies in the plane of symmetry. Furthermore, the third optical element may have structures extending in the horizontal direction, which are in particular cylindrical-lens-like. These structures forming the microlenses may be asymmetrical in the vertical direction.

According to a further embodiment, the second optical element is movable in the vertical direction. Thereby, it can be achieved that the radiation direction of the light emitted by the radiation emitting device can be changed, wherein a directional adaptation in the form of a leveling along the vertical direction can be achieved. For example, a mechanical device in the form of a mechanical drive may be provided to move the second optical element in the vertical direction. In addition, further or all optical elements of the optical system can also be movable in the vertical direction together with the second optical element.

The first, second and third optical elements may be the only optical elements of the optical system and in particular of the radiation emitting device.

The optical elements of the optical system, i.e. in particular the first, second and third optical elements, can be formed separately from each other and separately mounted in the radiation emitting device. In other words, the optical elements are formed as separate components. Further, the first and second optical elements or the first and third optical elements or the second and third optical elements or the first, second and third optical elements may be formed as one piece. In particular, a one-piece design may mean that elements formed in one piece are formed together by a single component. Such a one-piece component may be formed by a single component. For example, optical elements formed in one piece may be formed by different surfaces of such a component. Further, a one-piece component may be formed by fixedly joined components that have been previously manufactured separately, for example, fused or bonded components.

If the radiation emitting device has a housing body described above in which the laser light source is arranged, one optical element, several optical elements or all optical elements of the optical system can be arranged in or on the housing body and in particular mounted, for example by bonding. If all optical elements of the optical system are arranged in or on the housing body, a large compactness of the radiation emitting device can be achieved. It may be that at least one optical element of the optical system encloses with the housing body a hermetically sealed interior space in which at least the laser light source is arranged. “Hermetically sealed” can mean here and in the following in particular that damaging substances or other damaging influences from the surroundings cannot enter the interior space to such an extent that a damaging effect is caused thereby, for example, in the course of a usual expected or specified service life. Furthermore, an optical element of the optical system may form an exit window of the radiation emitting device through which the light is emitted into the surroundings.

The radiation emitting device described herein may form an emitter optics system for a measurement system, particularly for a LIDAR measurement system, and may be characterized by one or more of the following features:
The light emitted by the radiation emitting device in operation has an asymmetrical beam profile due to an asymmetrical radiation characteristic in the vertical direction. The light can thus be directed in an advantageous manner with the desired intensity distribution in the direction in which it is required.
The radiation emitting device has an array of emitters in the form of a plurality of laser emitter units. The array may be a one-dimensional array or a two-dimensional array. For example, the laser emitter units may be formed by surface emitting laser diodes, i.e., in particular, VCSEL laser diodes, edge emitting laser diodes, edge emitting laser diodes with beam redirection, or parts thereof.
At least one optical element of the optical system has or is formed of a microlens array with one-dimensional, horizontally or vertically extruded structures. The distance between each laser emitter unit and the surface of the microlens array is such that the beam from each laser emitter unit illuminates multiple microlens structures. This can result in a nearly identical vertical or horizontal light distribution for each laser emitter unit of the laser emitter unit array and, in the case of the third optical element, define the asymmetric beam profile in the vertical direction.
The first optical element defines the propagation of light in the horizontal direction, wherein the first optical element may be part of a bulk lens or a microlens array or part of a combined microlens array.
The radiation emitting device may be a laser package having a housing body containing the laser light source and at least one optical element or more or all of the optical elements of the optical system that produces a preformed asymmetric beam profile. At least one optical element may form an exit window for the light and/or a hermetic seal of the housing body, which may prevent contamination of the laser facets by harmful influences from the surroundings. By using at least one optical element as an exit window, the use of an additional optical window can be avoided, thereby reducing Fresnel reflections and system costs.
The housing body may include at least two electrical contacts through which the laser light source may be electrically contacted and operated.
The radiation emitting device may additionally include a leveling system that mechanically aligns, for example, the laser light source and at least one optical element to ensure that the highest intensity is emitted in the desired vertical direction. This may, for example, allow the use of the radiation emitting device, in particular a measurement system for a vehicle, on roads with different gradients or with different loads on the vehicle.
The radiation emitting device and, in particular, the measurement system comprising the radiation emitting device may be used in a vehicle such as a motor vehicle, for example, a passenger car or a truck.
The radiation emitting device and in particular the measurement system with the radiation emitting device can be used in a device in the form of a fixed installation for traffic or parking management, surveillance or industrial purposes.

### BRIEF DESCRIPTION OF THE DRAWINGS

Further advantages, advantageous embodiments and further developments are revealed by the embodiments described below in connection with the figures.

FIG. 1 shows a schematic illustration of a measurement system according to an embodiment,

FIGS. 2A and 2B show schematic illustrations of a vehicle and a device with a measurement system according to further embodiments,

FIGS. 3A to 6B show schematic illustrations of laser light sources and characteristics thereof according to further embodiments,

FIGS. 7A to 10 show schematic illustrations of radiation emitting devices according to further embodiments,

FIG. 11 shows a radiation pattern of a radiation emitting device according to another embodiment,

FIGS. 12A to 12T show schematic illustrations of radiation emitting devices according to further embodiments.

In the embodiments and figures, identical, similar or identically acting elements are provided in each case with the same reference numerals. The elements illustrated and their size ratios to one another should not be regarded as being to scale, but rather individual elements, such as for example layers, components, devices and regions, may have been made exaggeratedly large to illustrate them better and/or to aid comprehension.

### DETAILED DESCRIPTION

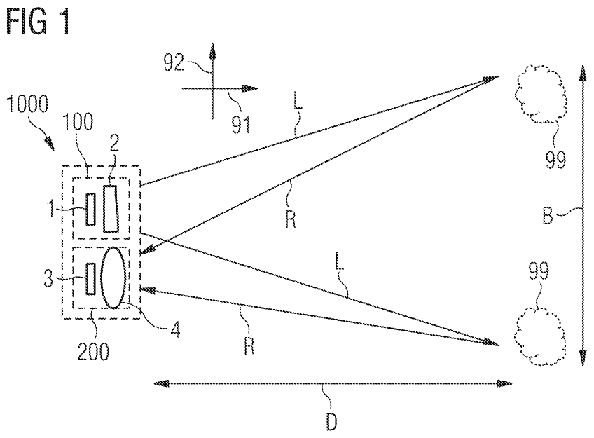

FIG. 1 shows an embodiment of a measurement system 1000 with a radiation emitting device 100 as transmitter unit and a detector unit 200 as receiver unit, with which objects 99 not belonging to the measurement system 1000, indicated in FIG. 1 by the dotted elements, can be detected. The objects 99 may be, for example, physical objects or persons or other objects that can be examined by means of light.

The radiation emitting device 100 of the measurement system 1000 is intended and embodied to emit a transmitter signal L during operation, as indicated by the correspondingly marked arrows in FIG. 1. For this purpose, the radiation-emitting device 100 comprises a laser light source 1 which, in operation, emits light along an emission direction 91. Furthermore, the radiation-emitting device 100 has an optical system 2 which is embodied to shape a radiation characteristic of the radiation-emitting device 100. In an embodiment, the optical system 2 is a non-imaging optical system. Further features of the radiation emitting device 100 will be explained in connection with subsequent figures.

For example, the radiation emitting device 100 may be configured to illuminate an area having a width B of several 10 m in a horizontal direction 92, for example, having a width B of at least 20 m or at least 30 m or at least 50 m, at a distance D of several 10 m, for example, at a distance D of at least 50 m or at least 100 m or at least 200 m. Furthermore, the area illuminated by the transmitter signal L can illuminate a height of several meters in a vertical direction, for example a height of at least 2 m or at least 5 m.

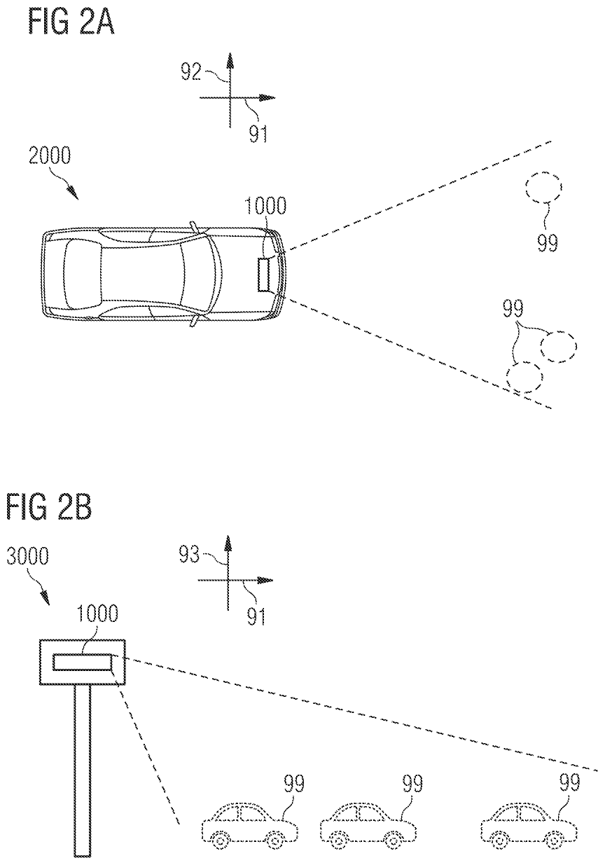

The directional indications “horizontal” and “vertical” may refer to such an arrangement of the measurement system 1000 in which the measurement system 1000 and, in particular, the radiation emitting device 100 in the measurement system 1000 are oriented relative to the surroundings for the intended use. For example, when the measurement system 1000 is used in a vehicle such as a road vehicle or in a monitoring device, as shown in connection with FIGS. 2A and 2B, the horizontal direction 92 may denote a direction parallel or at least substantially parallel to the road surface. The vertical direction 93, indicated for example in FIG. 2B, which is perpendicular to the horizontal direction, then corresponds to a direction perpendicular or at least substantially perpendicular to the road surface. The radiation direction 91 may be perpendicular or substantially perpendicular to the horizontal direction 92 and to the vertical direction 93. In subsequent figures, the directions 91, 92, 93 are indicated according to view and perspective for better understanding.

The transmitter signal L can, for example, be a light pulse emitted in the form of a single pulse with a specific pulse frequency. Furthermore, instead of a single pulse, the transmitter signal L can, for example, also have a pulse train, i.e. a plurality of pulses, and/or an amplitude-modulated pulse or an amplitude- and/or phase-modulated continuous light beam.

The detector unit 200 is intended and embodied to receive a return signal R comprising at least a part of the transmitter signal L reflected back from an external object 99. The return signal R may deviate from the transmitter signal L due to interaction of the transmitter signal L with an object 99, for example with respect to the time course, a spectral composition, an amplitude and/or a phase. For example, the return signal R may correspond to a transmitter signal L that is attenuated and/or at least partially frequency-shifted and/or phase-shifted with respect to at least some spectral components.

The detector unit 200 has at least one detector element 3, for example in the form of a photodiode or a photodiode array. For example, the detector unit 200 may comprise or be a SPAD array, an APD array or a gated imaging system. Furthermore, the detector unit 200 may comprise an optical system 4, which may be an imaging optical system.

The radiation emitting device 100 and the detector unit 200, and thus the laser light source 1, the optical system 2, the detector element 3 and the optical system 4, can be arranged in or on one or more housing bodies, as indicated by dashed lines in FIG. 1. In particular, the radiation emitting device 100 and the detector unit 200 may also be arranged in or on a common housing.

In a method for operating the measurement system 1000, the radiation emitting device 100 emits at least one light pulse as the transmitter signal L, as described. The detector unit 200 detects the return signal R. For example, the method may be used to determine one or more parameters related to the transmitter signal L and/or the return signal R to enable conclusions to be drawn about an object 99. For example, a time difference between the transmitter signal L and the return signal R and/or a wavelength shift and/or phase shift between the transmitter signal L and the return signal R and/or a spectral change between the transmitter signal L and the return signal R may be determined. From the one or more parameters determined from the return signal R, one or more state variables related to the object 99 can be derived, for example, a distance and/or a velocity and/or at least one or more velocity components. In particular, multiple objects can be detected simultaneously using an imaging optical system 4 and a detector array as detector element 3. For parameter determination, the measurement system 1000 may further comprise an evaluation unit intended and embodied for this purpose (not shown). In an embodiment, the measurement system 1000 has properties and features of a LIDAR system and may be a LIDAR system.

In FIGS. 2A and 2B, a vehicle 2000 with a measurement system 1000 and a monitoring device 3000 with a measurement system 1000 are indicated. The vehicle 2000 may be, for example, a road vehicle, a rail-bound vehicle, a water vehicle, or an aircraft. In an embodiment, the vehicle 2000 is a motor vehicle, as indicated in FIG. 2A. As indicated in FIG. 2B, the measurement system 1000 may be used in a device in the form of a fixed installation, such as the monitoring device 3000 shown. For example, the monitoring device 3000 may have the measurement system 1000 for a traffic management, parking management, security application, or industrial purposes.

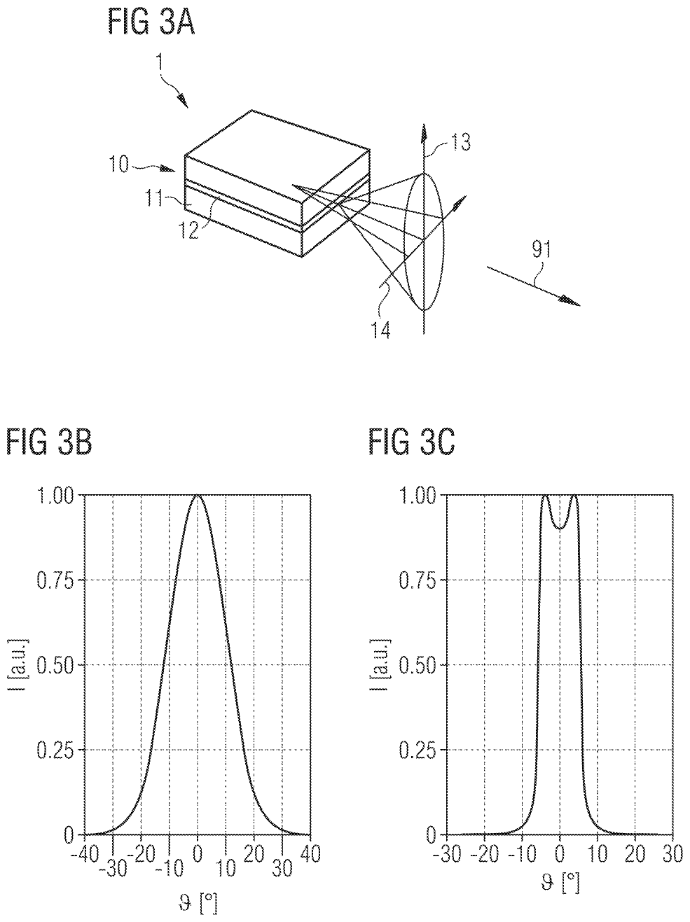

In connection with FIGS. 3A to 6B, embodiments of laser light sources 1 that may be used in the radiation emitting device 100 of the measurement system 1000 are shown. In particular, the laser light source 1 of the radiation emitting device 100 may include one or more laser emitter units 10.

In FIG. 3A, a semiconductor laser diode is shown as a laser light source 1, which is embodied as an edge-emitting laser diode and which forms a laser emitter unit 10. The semiconductor laser diode has a semiconductor layer sequence 11 with an active layer 12, which is embodied and intended to generate light in at least one active region during operation. The active layer 12 may form the semiconductor layer sequence 11 together with a plurality of semiconductor layers, and may have a main extension plane that is perpendicular to an arrangement direction of the layers of the semiconductor layer sequence 11. The semiconductor laser diode has a light outcoupling surface and a back surface opposite to the light outcoupling surface. The light outcoupling surface and the back surface can in particular be side surfaces of the semiconductor laser diode, such as side surfaces of the semiconductor layer sequence 11, which can also be referred to as so-called facets. Via the light outcoupling surface, the semiconductor laser diode can emit the light generated in the at least one active region of the active layer 12 during operation. Suitable optical coatings, in particular reflective or partially reflective layers or layer sequences, can be applied to the light outcoupling surface and the back surface, which can form an optical resonator for the light generated in the active layer 12. The at least one active region of the active layer 12 may extend between the back surface and the light outcoupling surface along a direction defining the resonator direction.

The active layer 12 and in particular the semiconductor layer sequence 11 with the active layer 12 may be deposited on a substrate (not shown). For example, the substrate may be formed as a growth substrate on which the semiconductor layer sequence 11 is grown. The active layer 12 and, in particular, the semiconductor layer sequence 11 with the active layer 12 may be grown by means of an epitaxial process, for example by means of metal organic vapor phase epitaxy (MOVPE) or molecular beam epitaxy (MBE). Furthermore, the semiconductor layer sequence 11 may be provided with electrical contacts (not shown) in the form of one or more contact elements. Furthermore, it may also be possible that the growth substrate is removed after the growth process. In this case, the semiconductor layer sequence 11 may also be transferred to a substrate formed as a carrier substrate, for example, after the growth process. The substrate may, for example, comprise or be made of sapphire, GaAs, GaP, GaN, InP, SiC, Si, Ge and/or a ceramic material such as SiN or AlN.

In an embodiment, the light generated by the laser light source 1 in operation is long wavelength light in the infrared spectral range and has a wavelength greater than or equal to 800 nm or greater than or equal to 850 nm. Further, the light may have a wavelength of less than or equal to 2 μm or less than or equal to 1.5 μm or less than or equal to 1 μm. A wavelength may be about 940 nm. For example, a semiconductor layer sequence 11 or at least one active layer 12 based on Inₓ Ga_{y} Al_{1-x-y} As or based on Inₓ Ga_{y} Al_{1-x-y} P is suitable for long-wave, infrared radiation, where in each case 0≤x≤1, 0≤y≤1 and x+y≤1 apply.

For example, the active layer 12 may have a conventional pn junction, a double heterostructure, a single quantum well (SQW) structure or a multiple quantum well (MQW) structure, or other light-generating structures suitable therefor. In addition to the active layer 12, the semiconductor layer sequence 11 may have additional functional layers and functional regions, such as p- or n-doped charge carrier transport layers, i.e., electron or hole transport layers, undoped or p- or n-doped confinement, cladding or waveguide layers, barrier layers, planarization layers, buffer layers, protective layers and/or electrode layers, and combinations thereof. Furthermore, additional layers, such as buffer layers, barrier layers and/or protective layers can also be arranged perpendicular to the growth direction of the semiconductor layer sequence 11, for example around the semiconductor layer sequence 11, i.e. for example on the side surfaces of the semiconductor layer sequence 11.

In the active layer 12, several active regions arranged next to each other perpendicular to the resonator direction can also be formed, which can be controlled independently of each other or optionally together. In such an embodiment, also referred to as a laser bar, the semiconductor laser diode 1 and thus the laser light source has a plurality of laser emitter units 10.

As indicated in FIG. 3A, the beam profile of the light generated by the edge-emitting laser diode in operation has a different aperture angle in a plane perpendicular to the main extension plane of the active layer 12 than in a plane parallel to the main extension plane of the active layer 12. This applies both to laser diodes oscillating in the so-called TM mode (TM: transverse magnetic) or in the so-called TE mode (TE: transverse electric). The plane or direction in which the beam profile has the largest aperture angle and which, in the embodiment shown, corresponds to the plane perpendicular to the main extension plane of the active layer 12, is also referred to as the fast axis 13, while the plane or direction in which the beam profile has the smallest aperture angle and which, in the embodiment shown, corresponds to the plane parallel to the main extension plane of the active layer 12, is referred to as the slow axis 14.

FIGS. 3B and 3C show typical examples of the normalized intensity I along the fast axis 13 and the slow axis 14 in the far field depending on the beam angle ϑ. The different beam angle is reflected in the widths of the intensity distributions, for example, at half maximum (FWHM: “full width at half maximum”) or at 10% intensity (FW10M: “full width at 10% of maximum”). In the embodiment shown, the FWHM along the fast axis is 25° and along the slow axis is 5°, while the FW10M along the fast axis is 45° and along the slow axis is 12°. In an embodiment, laser light sources 1 having such beam profiles with fast and slow axes are aligned in the radiation emitting device according to the embodiments described herein such that, for a beam profile with fast and slow axes, the fast axis of the light emitted from a laser light source 1 is aligned along the horizontal direction.

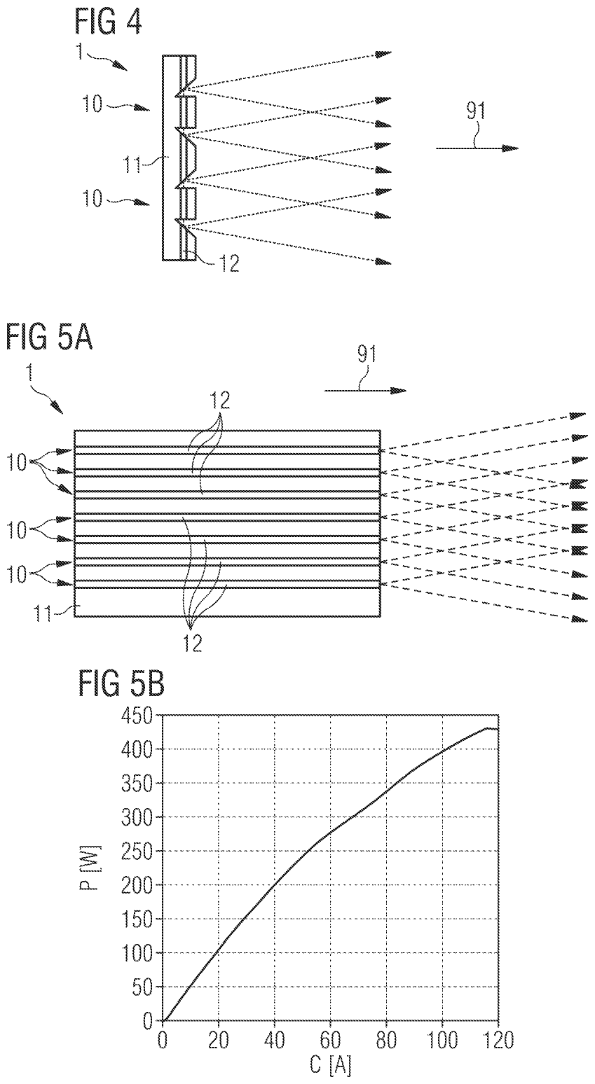

FIG. 4 shows another embodiment of a laser light source 1 comprising a plurality of laser emitter units 10. In this case, the laser light source is a so-called vertically emitting laser diode with a horizontal cavity, wherein the designations “horizontal” and “vertical” refer solely to the semiconductor laser diode and not to the directions defined in connection with the radiation emitting device. Accordingly, the vertical emission direction of the laser light source 1 shown in FIG. 4 is the emission direction 91 with respect to the radiation emitting device.

The laser light source 1 shown in FIG. 4 is based on the structure of an edge-emitting laser diode in which a plurality of facets are formed by trenches in the semiconductor layer sequence 11, via which light can be emitted parallel to the active layer 12 during operation. Surfaces of the semiconductor layer sequence 11 opposite to the facets and formed by the trenches are, for example, inclined at an angle of 45° and reflective, so that the light emitted thereon by the facets is emitted in a direction perpendicular to the main extension plane of the active layer, as indicated by the dashed arrows in FIG. 4.

For manufacturing the laser light source 1 shown in FIG. 4, after growing the semiconductor layer sequence 11, parts of this can be structured, for example by etching, into monolithically integrated deflection elements with a reflector surface. Opposite the reflector surfaces, the light outcoupling surfaces are formed so that, in operation, light emitted from the light outcoupling surfaces is irradiated onto the reflector surfaces. The reflector surfaces can be coated with a reflective coating, for example a metal coating or a Bragg mirror coating sequence. The deflector elements thus produced can be formed, for example, as straight prisms with a flat reflector surface or as curved prisms with a curved reflector surface that can serve, for example, to generate a circular light spot.

As an alternative to external reflector surfaces as shown in FIG. 4, the laser light source 1 can, for example, also have reflector surfaces which, by means of total reflection, deflect the light generated in the active layer 12 during operation in a direction perpendicular to the resonator direction before it emerges from the semiconductor layer sequence 11. Designs for such laser diodes are described in the publications DE 10 2007 062 050 B4 and US 2009/0097519 A1 from the same patent family, the disclosure contents of which are hereby incorporated in full.

In connection with FIGS. 5A and 5B, a further embodiment is shown for a laser light source 1 which, in comparison with the previous embodiments, has a plurality of laser emitter units 10 in the form of a plurality of active layers 12 which can be stacked on top of one another within the semiconductor layer sequence 11 and can be connected in series with one another, for example via tunnel junctions. Furthermore, contact elements, for example in the form of electrode layers, can also be provided for each active layer 12, via which the active layers 12 can be separately controlled. In an embodiment, the active layers 12 as well as the other layers of the semiconductor layer sequence 11 are grown in a tension-optimized manner.

Furthermore, each active layer 12 may also have multiple active regions formed adjacent to each other, resulting in a two-dimensional array of laser emitter units 10. The active areas arranged one above the other can, for example, be controllable together and form a channel, so that such a laser light source can have several multi-emitter channels. Purely by way of example, the laser light source 1 shown in FIG. 5A has seven active layers 12 stacked one on top of the other. Alternatively, there may be more or fewer active layers 12, for example three or five active layers.

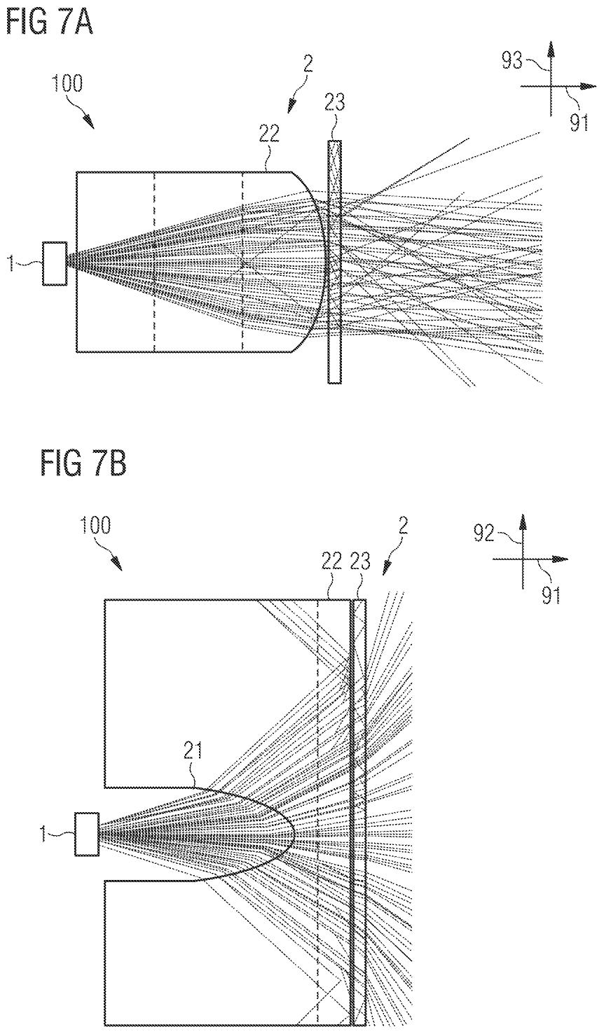

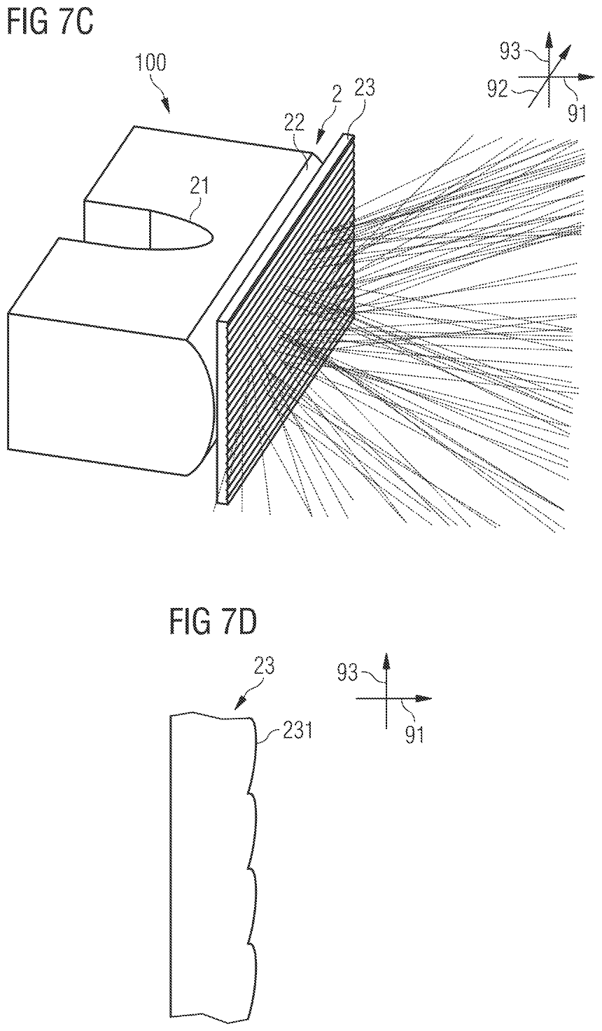

FIG. 5B shows a typical diagram for the output power P as a function of the operating current C for such a laser light source 1 for a pulsed light emission with a pulse length of 100 ns and a duty cycle of 0.001%. It was also shown that an operating current of, for example, 100 A and an output power of 560 W per channel are possible. Four channels may be sufficient to illuminate a 30 m wide area at 120 m distance. Such a laser light source 1 may be used, for example, in a radiation emitting device shown in connection with FIG. 7A and following, and may have an extremely compact package size with, for example, a lens diameter of substantially less than 1 mm and a focal length of less than 3 mm. The length of the laser light source 1 along the slow axis may be about 200 μm, the height along the fast axis about 28 μm

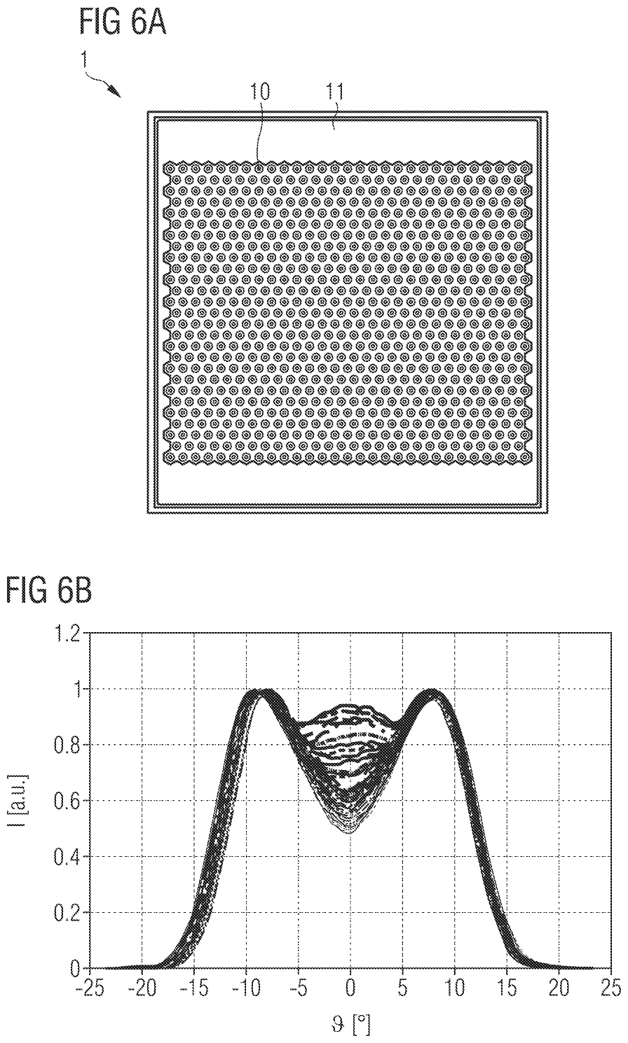

In connection with FIGS. 6A and 6B, a further embodiment is shown for a laser light source 1 which is embodied as a vertically emitting laser diode in the form of a semiconductor laser diode embodied as a VCSEL. As indicated in FIG. 6A in a top view of the light extraction surface and thus opposite to the radiation direction, the laser light source 1 may have a plurality of laser emitter units 10 which are formed by active regions formed vertically in the semiconductor layer sequence and which are arranged in a matrix-like manner, for example in a rectangular or hexagonal matrix. FIG. 6B shows a diagram with typical angle-dependent intensity distributions for different operating currents.

The laser light sources 1 shown by way of example in connection with FIGS. 3A to 6B have in common that, in the case of several laser emitter units, all laser emitter units may be operated in parallel and thus not separately from one another in order to obtain the simplest possible control. As a result, the respective radiation profile of the active area or areas substantially corresponds to the radiation profile of the laser light source 1. In order to convert this radiation profile into a radiation characteristic suitable for the measurement system, for example for the uses described in connection with FIGS. 1 to 2B, the radiation emitting device 100 according to the embodiments described in connection with the following figures comprises a non-imaging optical system 2 configured to shape a radiation characteristic of the radiation emitting device 100 in a horizontal direction and in a vertical direction. In particular, the optical system 2 is arranged to shape the radiation pattern such that the radiation pattern is asymmetrical along the vertical direction 93 in a desired manner and may be symmetrical along the horizontal direction 92, so that the radiation emitting device 100 in operation emits light into the surroundings that has an asymmetrical beam profile in the vertical direction 93. In this way, it can be achieved that the light is directed with a desired intensity distribution in those directions in which it is required with respect to the respective application, while in the horizontal direction 92 radiation is as uniform as possible to the left and right.

In connection with the following figures, embodiments of the radiation emitting device 100 are shown in which the optical system 2 comprises a plurality of optical elements 21, 22, 23 arranged along the radiation direction of the laser light source 1, respectively, for shaping the radiation characteristic of the radiation emitting device 100. The optical elements 21, 22, 23 may be the only components of the optical system 2 that contribute to shaping the radiation characteristic of the light emitted by the laser light source 1. Thus, the radiation emitting device 100 may have no other components in addition to the optical system 2 that significantly affect the radiation pattern. The optical elements 21, 22, 23 of the optical system 2 may be arranged in series along the radiation direction 91, as will be described below, although the sequences shown may also vary. In order to achieve the desired radiation characteristic for the radiation emitting device 100 which differs from the radiation characteristic of the laser light source 1, the optical elements 21, 22, 23 may have optical effects which are independent of one another with respect to the light emitted by the laser light source 1, the totality of these effects giving the desired radiation characteristic of the radiation emitting device 100. For the sake of clarity, only the laser light source 1 and the components of the optical system 2 are mostly shown in the following figures. These are, as explained in connection with FIG. 1, such as arranged in or on a common housing. The following embodiments each show optical systems 2 with a first optical element 21, a second optical element 22 and a third optical element 23.

The first optical element 21 of the optical system 2 is intended and configured to cause a spreading of the light emitted by the laser light source 1 along the horizontal direction 92. In particular, this can mean that the first optical element 21 changes the aperture angle of the light emitted by the laser light source 1 along the horizontal direction 92 in such a way that a desired angular range is illuminated in the horizontal direction 92. In an embodiment, the horizontal spreading causes an angle-dependent radiation intensity that is as uniform as possible in a desired angular range, which may be in particular larger than the aperture angle of the beam profile of the laser light source 1 along the horizontal direction 92. In particular, the horizontal spread may be symmetrical. In particular, this can mean that the angle-dependent beam intensity distribution in horizontal direction 92 is symmetrical to the left and to the right.

The second optical element 22 of the optical system 2 is intended and configured to effect collimation of the light along the vertical direction 93. In particular, this can mean that the second optical element 22 changes the aperture angle of the light emitted by the laser light source 1 along the vertical direction 93 in such a way that the illuminated angular range is smaller than the aperture angle of the beam profile of the laser light source 1 in the vertical direction 93.

The third optical element 23 of the optical system 2 is provided and configured to cause a radiation asymmetry along the vertical direction 93. In particular, this can mean that the radiation direction of the light emitted by the radiation emitting device 100, i.e. the light emerging from the optical system 2, is inclined with respect to the radiation direction 91 of the laser light source 1.

In connection with the embodiments described below, various combinations of the optical elements 21, 22, 23 are shown. Different dimensions of the radiation emitting device 100 result from permutations of the optical elements 21, 22, 23 and the use of different laser light sources 1. Generally, the smallest system is achieved with a laser light source 1 formed as a single edge emitting waveguide laser due to the high luminance of the light source. Edge emitting laser diodes or vertical emitting laser diodes with horizontal resonator may be arranged with the fast axis parallel to the horizontal direction 92, as mentioned above.

The optical elements 21, 22, 23 can each have one or more transparent plastics and/or one or more suitable glasses or, for example, also have a laminate structure with layers and/or areas with or of different materials in order to exhibit the desired optical properties. The optical elements 21, 22, 23 may be components separate from each other as described below, or may be formed in pairs or all together as a one-piece component. In all cases, the orientation with respect to the radiation direction 91 can be reversed for optical elements that are fused, bonded or manufactured as a common component in this manner, although not all variants are shown below for the sake of clarity. To reduce optical losses, the optical elements may be made in one piece, if this is possible, in order to reduce the number of surfaces and thus Fresnel reflection losses. In particular, the integration of the optical function in a housing body leads to miniaturization and at the same time reduces the number of surfaces.

In connection with FIGS. 7A to 7D, an embodiment of the radiation emitting device 100 is shown in different views according to the directions 91, 92, 93 respectively indicated, in which the first optical element 21, the second optical element 22, and the third optical element 23 are successively arranged downstream of the laser light source 1 in this order in the radiation direction 91 of the light irradiated from the laser light source 1. The beam path in different directions along the radiation direction 91 of the laser light source 1 is indicated in FIGS. 7A to 9C, respectively.

The first and second optical elements 21, 22 are integrally formed and have a common lens body, also referred to as a bulk lens. In particular, the first optical element 21 and the second optical element 22 each have a macroscopic lens surface, wherein, in the shown embodiment, the first optical element 21 is formed by the entrance surface into the lens body, while the second optical element 22 is formed by the exit surface of the lens body.

The first optical element 21 is formed as a concave lens surface in the form of a cylindrical lens-like lens surface having a partially elliptical or parabolic cross section extending in the vertical direction 93. Thus, symmetrical spreading of the light emitted from the laser light source 1 along the horizontal direction 92 can be achieved. The second optical element 22 is formed as a convex lens surface in the form of a cylindrical-lens-like lens surface extending in the horizontal direction 92. Thus, collimation of light along the vertical direction 93 can be achieved.

The third optical element 23 has a microlens array having a plurality of microlenses 231, as can be seen in particular in FIGS. 7C and 7D. The microlenses 231, while a distance between the laser light source 1 and the microlenses is selected to be sufficiently large, have such a small dimension in the vertical direction 93 that the light from the laser light source 1, and in particular the light from each laser emitter unit of the laser light source 1, is incident on a plurality of microlenses 231. As can be seen in FIG. 7C, the microlenses 231 are formed by structures extending one-dimensionally in the horizontal direction 92. In particular, each of the microlenses 231 is formed by a cylindrical lens each having a lens surface corresponding to a shape extruded in the horizontal direction 92, the lens surfaces corresponding to a part of a circumferential surface of a cylinder having at least partially round and/or angular base. The structures forming the microlenses may be asymmetrical in the vertical direction 93, as can be seen in FIG. 7D, so that the radiation direction of the light emitted by the third optical element 23 and thus by the optical system 2 is inclined in the vertical direction 93 with respect to the radiation direction 91 of the laser light source 1, as can be seen in particular in FIG. 7A.

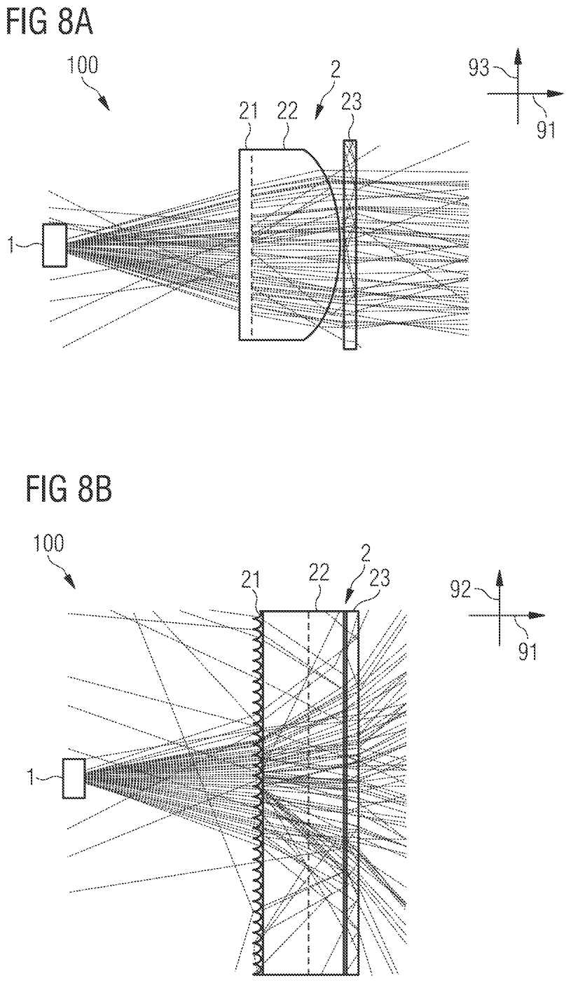

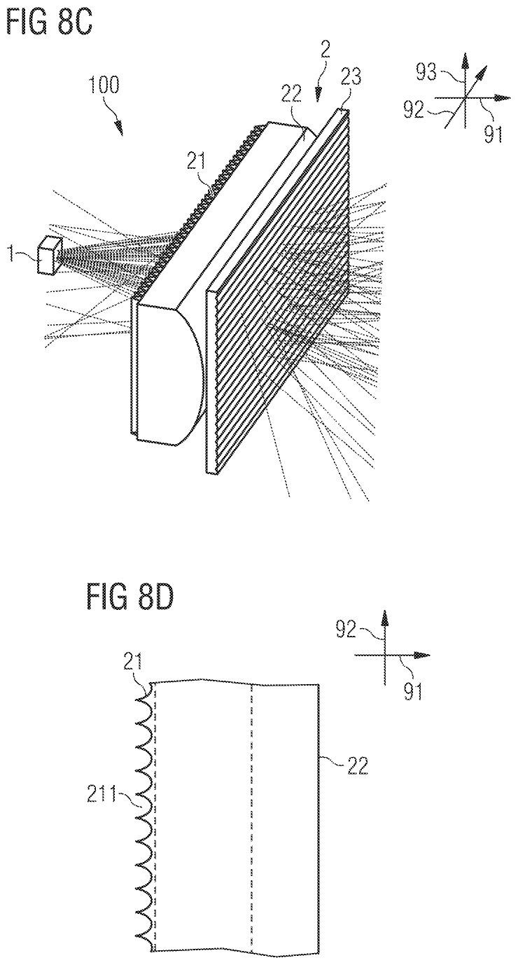

In connection with FIGS. 8A to 8D, a further embodiment is shown in which, compared with the previous embodiment, the first optical element 21 is formed as a microlens array having a plurality of microlenses 211, similar to the third optical element 23, as can be seen in particular in FIG. 8D. Compared to the third optical element 23, the microlenses 211 of the first optical element 21 extend in the form of cylindrical lenses along the vertical direction 93 and are symmetrically formed along the horizontal direction 92. Furthermore, the microlenses 211 of the first optical element 21 are not convex like the microlenses 231 of the third optical element 23, but are concave. In conjunction with a suitable distance of the first optical element 21 to the laser light source 1, the microlenses 211 of the first optical element 21 are formed to be so small along the horizontal direction 92 that the light of each laser emitter unit of the laser light source 1 falls on several microlenses. This makes it possible, in particular along the horizontal direction 92, to add further laser emitter units, for example in the form of additional semiconductor laser diodes or of broader laser bars with additional active areas, without having to modify the optical system 2. Thus, an adjustment of the light intensity of the laser light source 1 is possible in a simple way without having to change the optical system 2 due to a changed size of the laser light source 1, in particular along the horizontal direction 92.

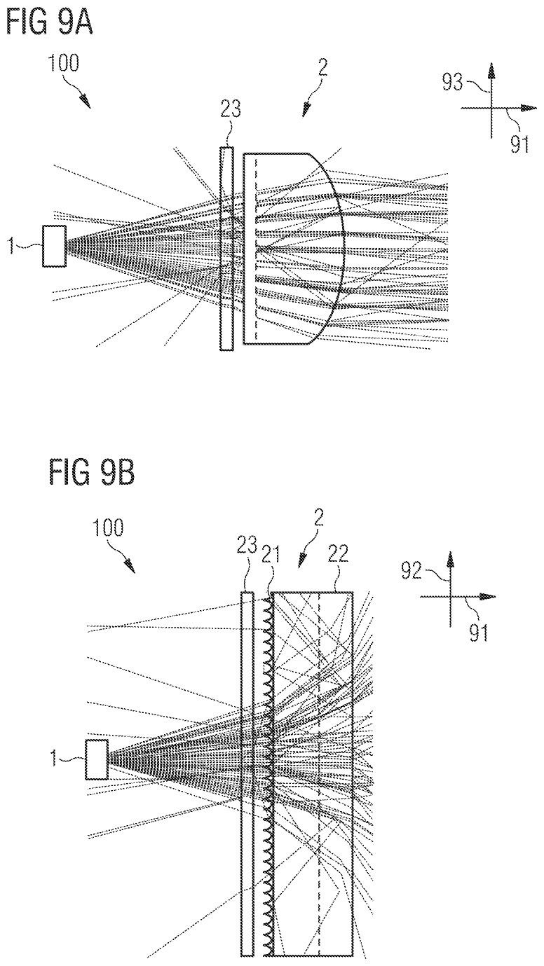

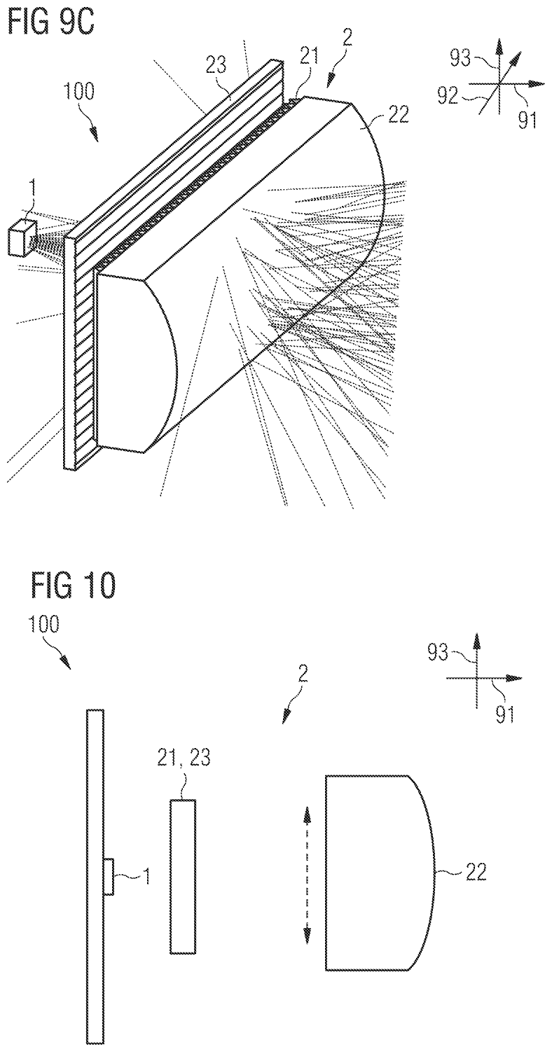

The shown sequences of the optical elements 21, 22, 23 may differ from the sequences shown in FIGS. 7A to 8D. In connection with FIGS. 9A to 9C, a further embodiment is shown accordingly, in which, purely by way of example, the third optical element 23 is arranged directly downstream of the laser light source 1 in the radiation direction 91 and the further optical elements 21, 22 formed in one piece are arranged downstream of the third optical element 23 in the radiation direction 91, the features and properties described above being retained. Furthermore, it may also be possible, for example, to form the first and third optical elements 21, 23 in one piece, which are then arranged downstream of the second optical element 22 in the radiation direction 91, wherein a reverse sequence is also possible, i.e. that the combined first and third optical elements 21, 23 are arranged downstream of the second optical element 22 in the radiation direction 91.

FIG. 10 shows a further embodiment in which, purely by way of example, the first and third optical elements 21, 23 are formed in one piece and the second optical element 22 is arranged downstream of them in the radiation direction 91. The second optical element 22 is further movable along the vertical direction 93, in particular relative to the laser light source 1, as indicated by the dashed double arrow. This may allow the direction of emission of the light emitted by the radiation emitting device 100 to be changed, thereby providing directional adaptation in the form of leveling along the vertical direction 93. For example, a mechanical device in the form of a mechanical drive may be provided to move the second optics element 22 in the vertical direction 93. In addition, further or all optical elements of the optical system 2 may also be movable together with the second optical element 22 in the vertical direction 93.

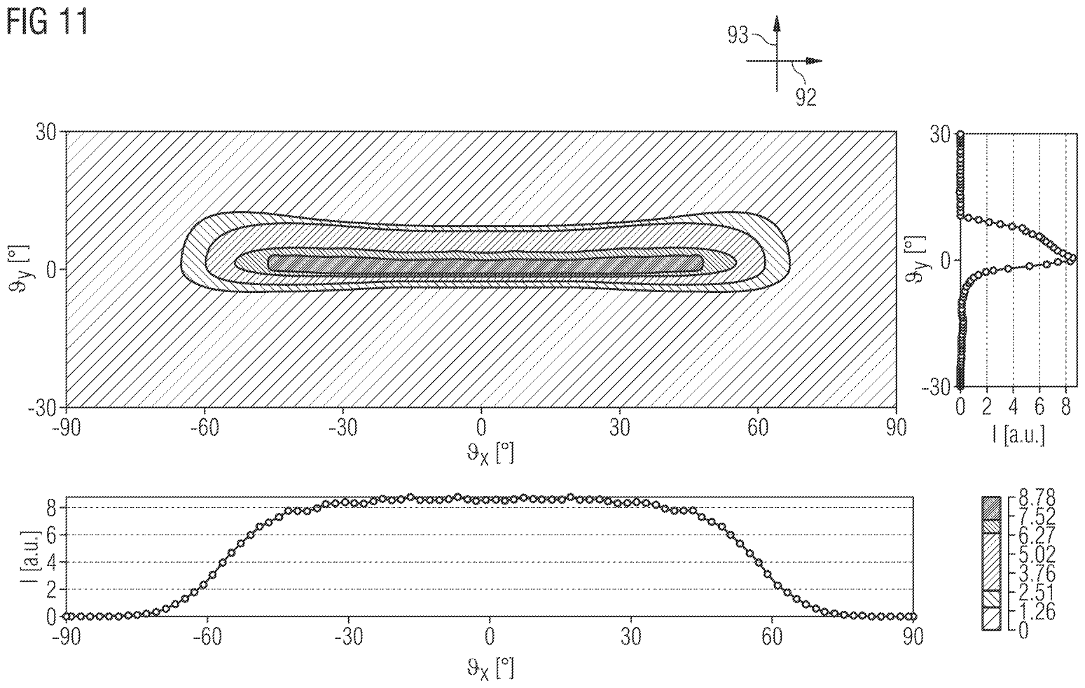

FIG. 11 shows an example of an angle-dependent intensity distribution I in the far field that can be achieved with the radiation emitting device described here as a function of the emission angle ϑₓ in the horizontal direction 92 and as a function of the emission angle ϑ_{y} in the vertical direction 93. With the optical system described herein, an efficiency of more than 70% or even more than 80% can be achieved. It can be easily seen that uniform spreading along the horizontal direction 92 can be achieved in a wide angular range, which is significantly larger than the beam profile aperture angle of the laser light source 1 in the horizontal direction 92 related to the radiation emitting device. At the same time, collimation and additionally asymmetry along the vertical direction 93 can be achieved.

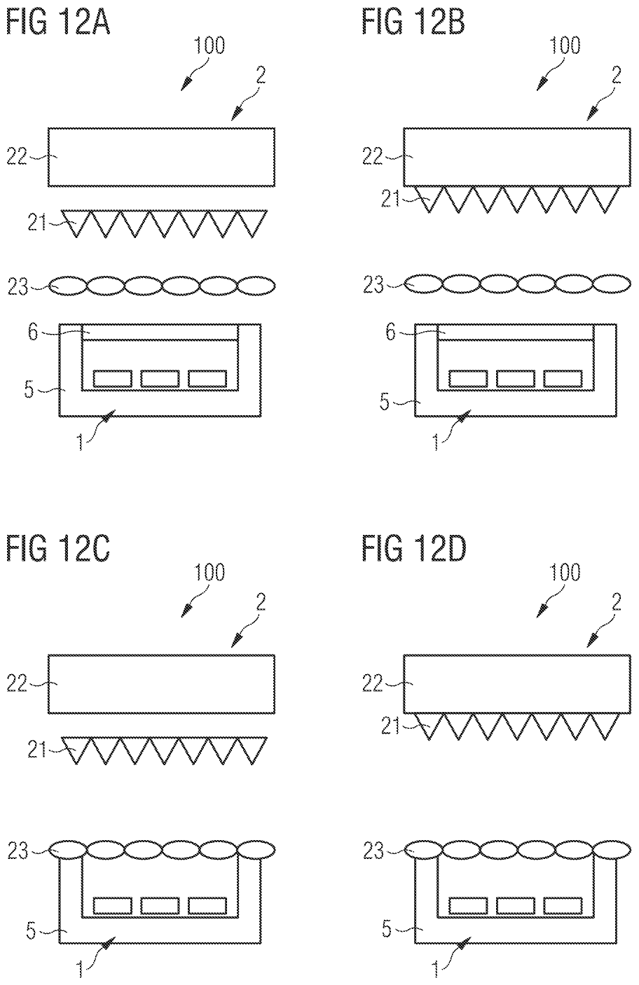

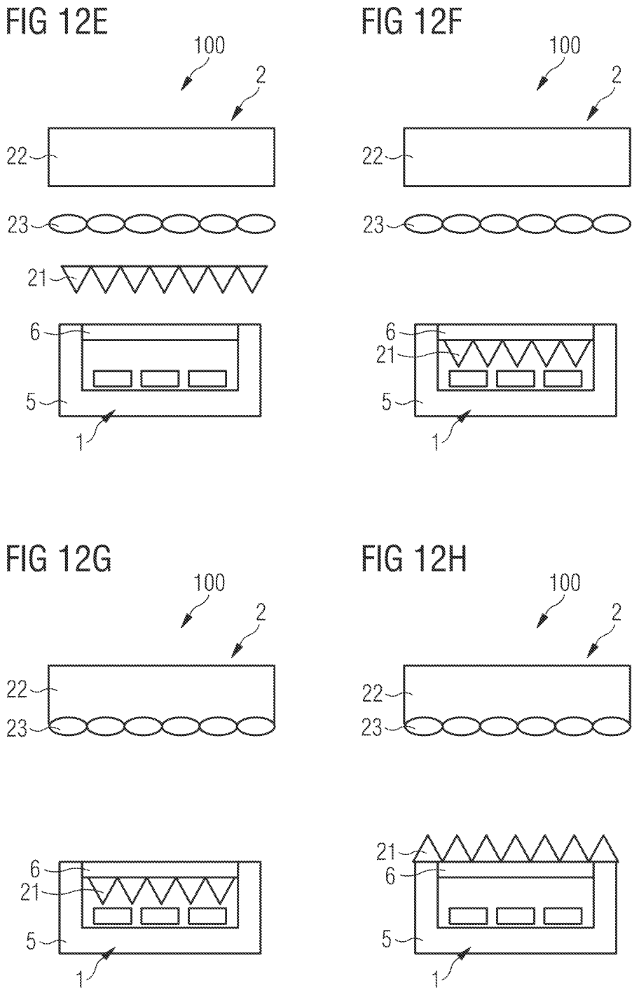

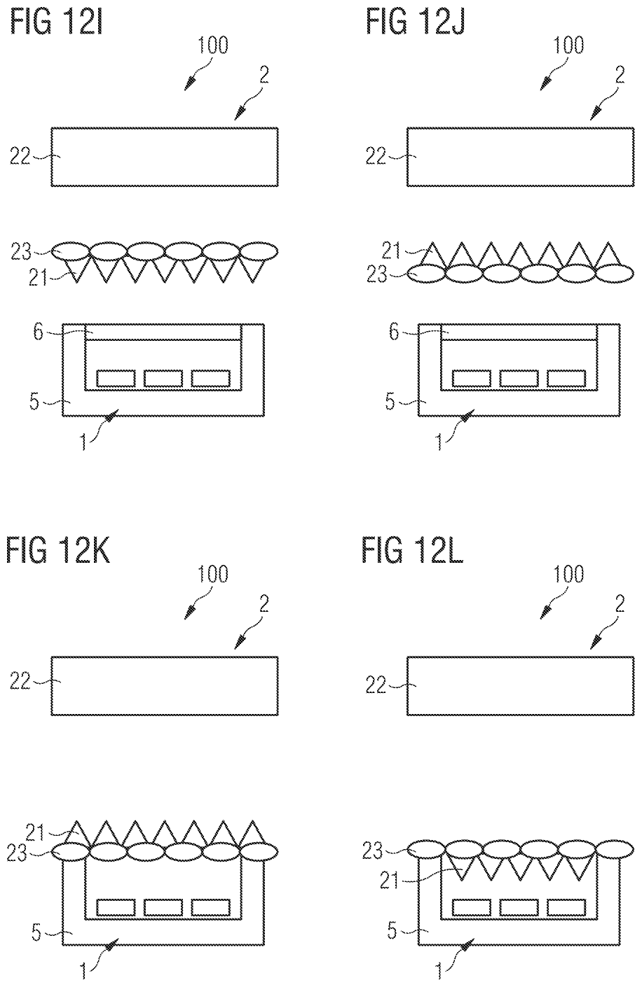

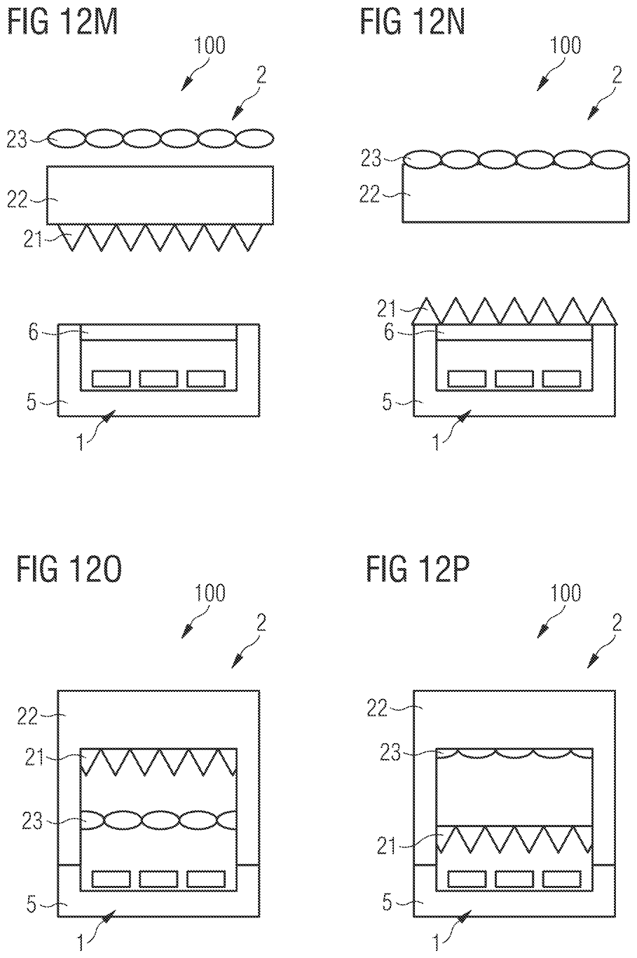

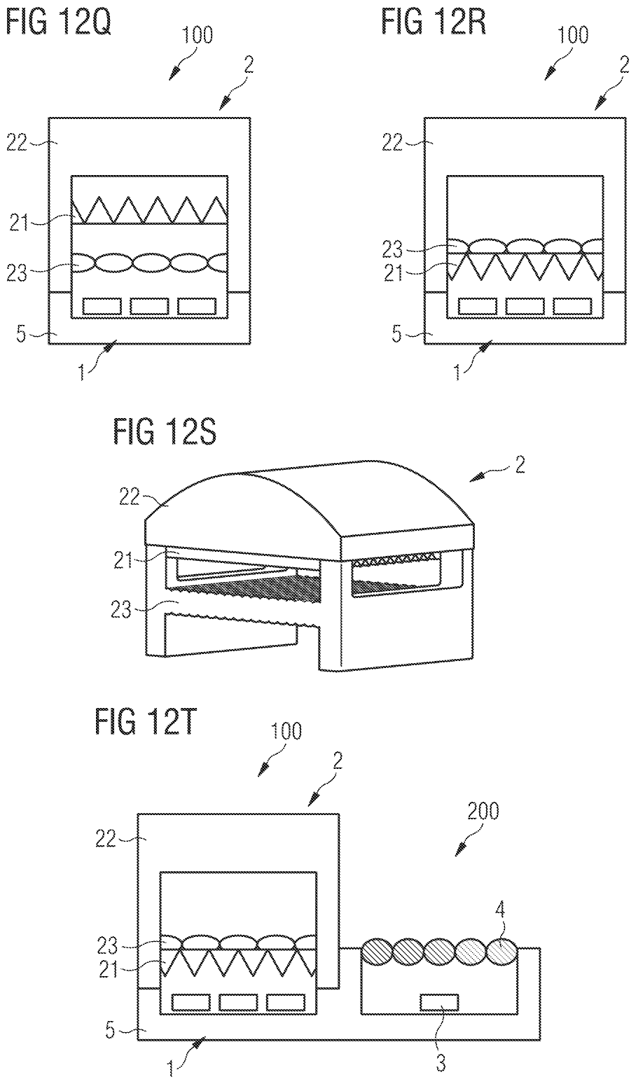

In connection with FIGS. 12A to 12T, further embodiments of the radiation emitting device 100 are shown, by means of which some possible arrangement concepts of the laser light source 1 and the optical system 2 are to be illustrated. In all embodiments, at least the laser light source 1, which is purely exemplarily indicated in the form of three semiconductor laser diodes each forming at least one laser emitter unit, is arranged in a housing body 5. The housing body 5 may, for example, comprise a plastic housing, a lead frame, a printed circuit board, a ceramic carrier or combinations thereof and enable mounting and electrical connection of the laser light source 1 by means of suitable electrical contacts.

As can be seen in FIG. 12A, in this embodiment the housing body 5 has a transparent cover 6, for example with or made of a plastic or glass, through which the light generated by the laser light source 1 in operation is coupled out of the housing body 5. The cover 6 may provide a hermetic seal of the housing body 5 to protect the laser light source 1 from damaging external influences.

In this embodiment, the third optical element 23, the first optical element 21 and the second optical element 22 are formed as separate components and are arranged in this order downstream of the laser light source 1 along the radiation direction of the laser light source 1. The radiation emitting device 100 may comprise a further housing body in or on which the housing body 5 and the optical system 2 are arranged.

In the embodiment shown in FIG. 12B, the first and second optical elements 21, 22 are formed in one piece and are arranged downstream of the third optical element 23, as also described, for example, in connection with FIGS. 9A to 9C.

In FIGS. 12C and 12D, the same sequences of optical elements 21, 22, 23 are shown with respect to the radiation direction, with the third optical element 23 in each case being formed as a cover for the housing body 5 and being mounted accordingly as an exit window on or in the housing body 5.

The embodiment shown in FIG. 12E corresponds to the embodiment shown in FIG. 12A, but the order of the optical elements 21, 22, 23 is interchanged. In particular, the first optical element 21, the third optical element and the second optical element 22 are arranged downstream of the laser light source 1 in this order.

In the embodiment shown in FIG. 12F, the first optical element 21 is integrally formed with the cover 6 and arranged in the housing body 5. In the embodiment of FIG. 12G, furthermore, the second and third optical elements 22, 23 are integrally formed, while in comparison, in the embodiment of FIG. 12H, the first optical element 21 is integrally formed with the cover 6, but is arranged outside the housing body 5. In the embodiments of FIGS. 121 and 12J, the first and third optical elements 21, 23 are formed in one piece and the second optical element 22 is arranged downstream of each of them in the radiation direction, wherein in FIG. 12I the third optical element 23 is arranged downstream of the first optical element 21, while in FIG. 12J the first optical element 21 is arranged downstream of the third optical element 23.

In the embodiments of FIGS. 12K and 12L, compared to the embodiments of FIGS. 121 and 12J, the integrally formed optical elements 21, 23 form the cover of the housing body 5 and are thus mounted to or within it.

In the embodiment of FIG. 12M, the first and second optical elements 21, 22 are integrally formed and the third optical element 23 is arranged downstream thereof. This arrangement thus corresponds to the arrangement shown in connection with FIGS. 7A to 8D.

In the embodiment shown in FIG. 12N, the first optical element 21 is formed integrally with the cover 6, while, downstream of it, the second and third optical elements 22, 23 are also formed integrally.

In FIG. 12O, an embodiment is shown in which the first, second and third optical elements 21, 22, 23 are integrally formed, i.e. form a one-piece optical element 2 that forms a cover element for the housing body 5, wherein the first and second optical elements 21, 22 are directly adjacent to each other as shown in FIG. 12B, while the third optical element 23 is spaced apart from the first optical element 21. In comparison, in the embodiment of FIG. 12P, the first and third optical elements 21, 23 are interchanged with each other.

In the embodiment of FIG. 12Q, the optical elements 21, 22, 23 also form a one-piece optical system 2, but the optical elements 21, 22, 23 are each formed at a distance from one another.

In the embodiment of FIG. 12R, however, the first and third optical elements 21, 23 are directly adjacent to each other. FIG. 12S shows in a three-dimensional illustration an exemplary configuration for such an optical system 2 which, in comparison with the embodiment of FIG. 12R, can be used in connection with a cover on the housing body and which can be mounted on the cover and/or the housing body. In particular, the optical system 2 shown in FIG. 12S can be manufactured in one piece and thus as one part. This has the advantage that the optical elements do not have to be adjusted with respect to each other and the construction of such a component can be substantially simplified.

In FIG. 12T, an embodiment for the radiation emitting device 100 is shown, which comprises a common housing body 5 with a detector unit 200 comprising a detector element 3 and an optical system 4, as for example also explained in connection with FIG. 1. In this context, it is advantageous if the housing body 5 has an optical separation between the laser light source 1 and the detector unit 3 as shown, for example in the form of a partition wall. Purely by way of example, the optical system 2 of the radiation-emitting device 100 is embodied as in the embodiment of FIG. 12R. Alternatively, the optical system 2 may also be embodied as explained in connection with the other figures. The optical system 4 of the detector unit 200 may comprise one or more optical elements and, in contrast to the optical system 2 of the radiation emitting device 100, may be an imaging optical system.

The features and embodiments described in connection with the figures can be combined with each other according to further embodiments, even if not all combinations are explicitly described. Furthermore, the embodiments described in connection with the figures may alternatively or additionally have further features according to the description in the general part.

The invention is not limited by the description based on the embodiments to these embodiments. Rather, the invention includes each new feature and each combination of features, which includes in particular each combination of features in the patent claims, even if this feature or this combination itself is not explicitly explained in the patent claims or embodiments.

1. A radiation emitting device for emitting light, wherein the device comprises:
a laser light source configured to emit the light along an emission direction; and
a non-imaging optical system arranged downstream of the laser light source in the emission direction;
wherein:
the optical system comprises a plurality of optical elements arranged along the radiation emitting direction for shaping a radiation characteristic of the radiation emitting device in a horizontal direction and in a vertical direction perpendicular to the horizontal direction such that the radiation characteristic along the vertical direction is asymmetric,
a first optical element of the optical system is intended and configured to cause a spreading of the light along the horizontal direction,
a second optical element of the optical system is provided and configured to effect collimation of the light along the vertical direction,
a third optical element of the optical system is intended and configured to effect radiation asymmetry along the vertical direction.

2. The radiation emitting device according to claim 1, wherein the first optical element and/or the third optical element comprises a microlens array having a plurality of microlenses.

3. The radiation emitting device according to claim 2, wherein the laser light source comprises at least one laser emitter unit and each of the at least one laser emitter unit is configured to emit light onto a plurality of the microlenses.

4. The radiation emitting device according to claim 2, wherein the microlenses are formed by structures extending in one direction.

5. The radiation emitting device according to claim 4, wherein each of said microlenses is formed by a cylindrical lens.

6. The radiation emitting device according to claim 4, wherein the first optical element comprises structures extending in the vertical direction.

7. The radiation emitting device according to claim 4, wherein the third optical element comprises structures extending in the horizontal direction.

8. The radiation emitting device according to claim 7, wherein the structures are asymmetric in the vertical direction.

9. The radiation emitting device according to claim 1, wherein the second optical element comprises a lens body.

10. The radiation emitting device according to claim 1, wherein the second optical element is movable in the vertical direction.

11. The radiation emitting device according to claim 1, wherein the first, second, and third optical elements are formed separately from each other.

12. The radiation emitting device according to claim 1, wherein at least two optical elements are integrally formed.

13. (canceled)

14. The radiation emitting device according to claim 1, further comprising a housing body in which the laser light source is arranged, wherein the optical elements of the optical system are arranged in or on the housing body.

15. The radiation emitting device according to claim 14, wherein at least one optical element of the optical system encloses with the housing body a hermetically sealed interior space in which at least the laser light source is disposed.

16. The radiation emitting device according to claim 1, wherein an optical element of the optical system forms an exit window of the radiation emitting device through which the light is emitted into the surroundings.

17. The radiation emitting device according to claim 1, wherein the laser light source is oriented such that a fast axis of the emitted light is aligned along the horizontal direction.

18. A measurement system comprising:
a radiation emitting device according to claim 1; and
a detector unit.

19. The measurement system according to claim 18, wherein the laser light source and the detector unit are arranged in a common housing body.

20. A vehicle with a measurement system according to claim 18.

21. A radiation emitting device for emitting light, wherein the device comprises:
a laser light source configured to emit the light along an emission direction; and
a non-imaging optical system arranged downstream of the laser light source in the emission direction;
wherein:
the optical system comprises a plurality of optical elements arranged along the radiation emitting direction for shaping a radiation characteristic of the radiation emitting device in a horizontal direction and in a vertical direction perpendicular to the horizontal direction such that the radiation characteristic along the vertical direction is asymmetric,
a first optical element of the optical system is intended and configured to cause a spreading of the light along the horizontal direction,
a second optical element of the optical system is provided and configured to effect collimation of the light along the vertical direction,
a third optical element of the optical system is intended and configured to effect radiation asymmetry along the vertical direction,
the third optical element comprises a microlens array having a plurality of microlenses.
